(19) United States
(12) Patent Application Publication
(10) Pub. No.: US 2008/0125938 A1
(43) Pub. Date: May 29, 2008

(54) AUTOMATED AUTOMOBILE GUIDANCE SYSTEM

(76) Inventor: Brien E. Pierpont, St. Petersburg, FL (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/557,138

(22) Filed: Nov. 7, 2006

(51) Int. Cl. B62D 6/00; B60K 31/00; G01S 5/00

(52) U.S. Cl. 701/41

(57) ABSTRACT

An automobile guidance system having an automobile with an exterior, a gas pedal, a brake pedal, and a steering wheel. The system also has a global positioning system and a plurality of ultrasound/radiofrequency detectors/transmitters in communication with a control unit within the automobile. The control unit receives information from the ultrasound/radiofrequency detectors/transmitters and/or the global positioning system. Then, based upon this information the control unit is able to actuate the gas pedal, the brake, and steering wheel to operate the automobile.

### BACKGROUND OF THE INVENTION

This invention relates to an automated automobile guidance system. More specifically, this invention relates to an automobile guidance system that utilizes GPS and/or ultrasound/radiofrequency technology to automatically operate a vehicle.

Driving on today's highways can not only be tiring but additionally dangerous. Many drivers tailgate, fall asleep at the wheel, or experience distractions such as rowdy children or the need to talk on cell phones that tends to cause accidents and dangerous situations. Additionally, individuals on long trips often become tired easily and are forced to spend multiple days traveling and make multiple stops in order to allow them to sleep or rest from the driving.

Therefore, a principal object of the present invention is to provide an automated automobile guidance system that operates an automobile on a highway.

Another object of the present invention is to improve highway safety.

These and other objects, features or advantages of the present invention will become apparent from the specification and claims.

### BRIEF SUMMARY OF THE INVENTION

An automobile guidance system for use on a highway. The automobile has an exterior that contains a plurality of ultrasound/radiofrequency detectors/transmitters. These ultrasound/radiofrequency detectors/transmitters communicate with a control unit within the automobile using detectors/transmitters that are associated with the highway. The control unit may also receive information from a Global Positioning System (GPS) and based upon the information from the ultrasound/radiofrequency detectors/transmitters and/or the GPS, the control unit actuates a gas pedal, a brake pedal, and a steering wheel.

### BRIEF DESCRIPTION OF THE DRAWINGS

FIG. 1 is a schematic view of an automobile guidance system.

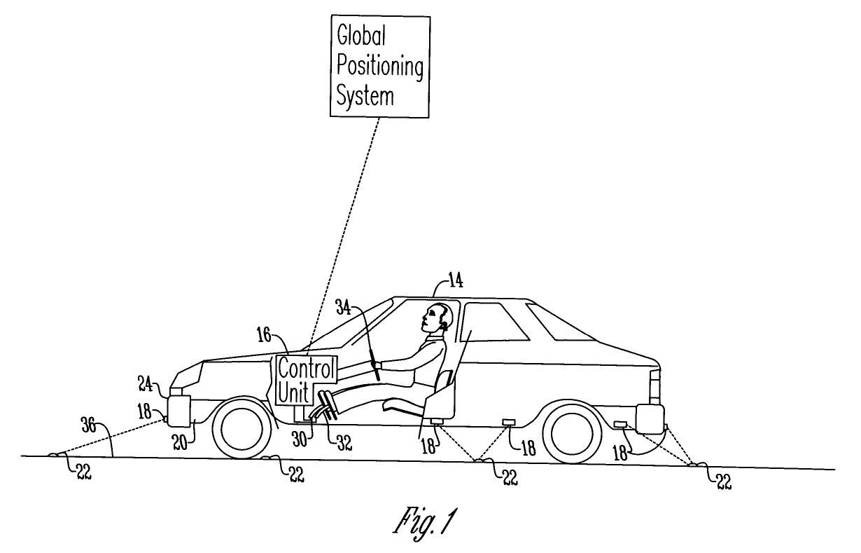

### DETAILED DESCRIPTION OF THE PREFERRED EMBODIMENT

The FIGURE shows an automobile guidance system 10 that uses a global positioning system (GPS) 12 that is in communication with an automobile 14. The automobile 14 has a control unit 16 therein that communicates with the GPS 12 and/or communicates with a plurality of ultrasound/radiofrequency detectors/transmitters 18 that are located on the exterior 20 of the automobile 14. The GPS information and/or the ultrasound/radiofrequency detectors/transmitters 18 are used in combination with transmitters/detectors 22 to provide positioning information to the control unit 16.

The automobile 14 has an exterior 20 including at least one bumper 24. Within the automobile 14 is a gas pedal 30, a brake pedal 32 and a steering wheel 34 all of which are mechanically connected to the control unit 16 such that the control unit 16 may actuate them as information is received.

The ultrasound/radiofrequency detectors/transmitters 18 communicate with the transmitters/detectors 22. In this embodiment the transmitters/detectors 22 are shown as detector/transmitter dots on a road or highway 36. Thus, the transmitters/detectors 22 of the automobile guidance system 10 can be adapted for use with detectors already used on highways 36. Though shown as on the highway 36 the transmitters/detectors 22 could be placed on other items associated with the highway 36 without varying from the scope of this invention.

In operation, the automobile guidance system 10 is activated by a user on a highway 36. At this point, the control unit 16 communicates with the GPS 12 and/or the ultrasound detectors/transmitters 18 to determine the position of the automobile 14. Meanwhile the ultrasound/radiofrequency detectors/transmitters 18 are used to send signals to or record signals from transmitters/detectors 22 and to send signals to and record signals from other vehicles to effect the proper positioning of the automobile on the highway 36. Specifically, the ultrasound/radiofrequency detectors/transmitters 18 are positioned around the entire perimeter of the automobile to generate information that is fed back to the control unit 16 and translate the information mechanically to properly steer the vehicle to maintain the vehicle's position on the highway 36.

By having ultrasound/radiofrequency detectors/transmitters 18 on the front bumper 24 the system 10 has the capacity to detect another vehicle to make appropriate adjustments in the acceleration and deceleration of the vehicle thereby maintaining a safe distance from the vehicle which has been detected in front. Specifically when another automobile in front of the vehicle slows, the control unit 16 can make appropriate adjustments in speed by a degree of braking. Also, by having the ultrasound/radiofrequency detectors/transmitters 18 around the perimeter of the vehicle other vehicles and/or other objects may be detected allowing appropriate adjustments to be made in speed and direction to avoid collisions with other vehicles and objects. Similarly upon detection of an obstruction in the highway such as an accident or road construction the control unit 16 can be programmed to slow down, stop, or change position/lanes depending on the obstruction. Positional changes of the vehicle to maintain safe distances and avoid collisions can also be effected by or assisted by the GPS system.

Radiofrequency, ultrasonic transmission, or similar transmissions of the speed limit can also be transmitted to the control unit 16 so that the system 10 can make appropriate velocity adjustments. Specifically adjustments in cruise control can be controlled in response to the speed transmissions.

Once a vehicle operator decides to no longer use the automobile guidance system 10, the system 10 may be deactivated and the operator is then in full control of the vehicle manually. Alternatively, when the automobile exits a freeway and proceeds to an area where manual control of the vehicle is mandatory, while the control unit 16 is still operating the vehicle, the control unit can be programmed to pull the vehicle to the side of the road to a complete stop and initiate the flashers of the vehicle if manual control of the vehicle is not accomplished in a timely fashion. This prevents accidents when an individual is sleeping or is inattentive and their destination has been reached. Before the automated guidance system is deactivated, the control unit 16 has an automated voice countdown to alert the driver of when the system 10 is no longer in operation. The guidance system can be manually activated or deactivated by the driver at any time.

Thus, disclosed is an automobile guidance system 10. The system 10 allows an automobile 14 to be operated by a control unit 16 in combination with ultrasound/radiofrequency detectors/transmitters 18, transmitters/detectors 22 and/or a GPS 12 without the assistance or need of operator input. The system additionally is able to identify other vehicles and obstructions, and the location of the automobile on a highway to safely navigate travel. This travel is done without tailgating and allows for an operator to sleep or partake in other activities while on the highway. Thus, not only is safety improved but an individual can travel longer distances before needing to stop. As such, at the very least, all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. An automobile guidance system comprising:
an automobile having an exterior, a gas pedal, a brake pedal and a steering wheel;
a plurality of detectors/transmitters on the exterior of the automobile;
a global positioning system in communication with a control unit within the automobile;
wherein the control unit receives information from the detectors/transmitters and/or the global positioning system;
wherein the control unit actuates at least one of the gas pedal, the brake pedal or the steering wheel in response to the information received.

2. The system of claim 1 wherein the detectors/transmitters are located on a bumper of the automobile.

3. The system of claim 1 further comprising detectors/transmitters detached from the automobile and in communication with the detectors/transmitters.

4. The system of claim 3 wherein the detectors/transmitters are associated with a highway.

5. The system of claim 1 wherein the control unit receives additional information regarding a speed limit and actuates at least one of the gas pedal or brake pedal in response to the additional information.

6. The system of claim 5 wherein the control unit actuates the gas pedal via a cruise control in response to the additional information.

7. The system of claim 1 wherein the control unit is adapted to stop the automobile in response to information received.
